(19) United States
(12) Patent Application Publication
(10) Pub. No.: US 2021/0284337 A1
(43) Pub. Date: Sep. 16, 2021

(54) UNMANNED AERIAL VEHICLE, COMMUNICATION SYSTEM AND TESTING METHOD, DEVICE AND SYSTEM THEREOF

(71) Applicant: SZ DJI TECHNOLOGY CO., LTD., Shenzhen (CN)

(72) Inventors: Changxin HE, Shenzhen (CN); Hanping CHEN, Shenzhen (CN); Yong YANG, Shenzhen (CN)

(21) Appl. No.: 17/333,000

(22) Filed: May 27, 2021

Related U.S. Application Data
(63) Continuation of application No. PCT/CN2018/118706, filed on Nov. 30, 2018.

(51) Int. Cl. B64C 39/02; H04L 29/08; H04L 12/40

(52) U.S. Cl. CPC B64C 39/024; H04L 67/2852; H04L 12/40052; H04L 2012/40273; B64C 2201/127; H04L 2012/40215; B64C 2201/146

(57) ABSTRACT

An unmanned aerial vehicle includes a communication controller configured to receive a control instruction from a remote control, a flight controller electrically connected to the communication interface through a communication interface and a universal serial bus (USB) interface, and a center board controller electrically connected to the flight controller through a controller area network (CAN) bus and electrically connected to a load of the unmanned aerial vehicle. The communication interface is configured to transmit the control instruction. The USB interface is configured to transmit upgrade data of the flight controller. The flight controller is configured to control the unmanned aerial vehicle according to the control instruction. The center board controller is configured to receive the control instruction from the communication controller and forward the control instruction to the load.

### CROSS-REFERENCE TO RELATED APPLICATION

This application is a continuation of International Application No. PCT/CN2018/118706, filed Nov. 30, 2018, the entire content of which is incorporated herein by reference.

### TECHNICAL FIELD

The present disclosure relates to the field of unmanned aerial vehicle technologies and, more particularly, to an unmanned aerial vehicle, a communication system and testing method, device, and system thereof.

### BACKGROUND

Usually, an unmanned aerial vehicle is controlled by a remote control. For example, a user can use the remote control to control flight attitude of an unmanned aerial vehicle, control an angle of the gimbal mounted at an unmanned aerial vehicle, and control a camera mounted at an unmanned aerial vehicle to take pictures.

In existing technologies, when a user uses a remote control to control an unmanned aerial vehicle, interaction between multiple controllers inside the unmanned aerial vehicle is involved. At present, the controllers of the unmanned aerial vehicle mainly use a Controller Area Network (CAN) bus for communication. Specifically, a communication controller of the unmanned aerial vehicle can receive control instructions from the remote controller, and send the control instructions to a flight controller or a center board controller through the CAN bus. For example, when a control instruction is used to control flight attitude of the unmanned aerial vehicle, it can be sent to the flight controller for realizing flight control through the CAN bus. As another example, when a control instruction is used to control an angle of a gimbal mounted at the unmanned aerial vehicle, the control instruction can be sent to the center board controller through the CAN bus, and the center board controller can send control signals to the gimbal. Further, other data besides the control instructions between controllers can also be exchanged through the CAN bus, such as upgrade data, logs, etc. Since the controllers of the unmanned aerial vehicle share the CAN bus, there will be too much data on the CAN bus for a period of time.

Therefore, in the existing technologies, there are problems of packet loss and large time delays on the CAN bus.

### SUMMARY

In accordance with the disclosure, there is provided an unmanned aerial vehicle including a communication controller configured to receive a control instruction from a remote control, a flight controller electrically connected to the communication interface through a communication interface and a universal serial bus (USB) interface, and a center board controller electrically connected to the flight controller through a controller area network (CAN) bus and electrically connected to a load of the unmanned aerial vehicle. The communication interface is configured to transmit the control instruction. The USB interface is configured to transmit upgrade data of the flight controller. The flight controller is configured to control the unmanned aerial vehicle according to the control instruction. The center board controller is configured to receive the control instruction from the communication controller and forward the control instruction to the load.

### BRIEF DESCRIPTION OF THE DRAWINGS

The above and/or additional aspects and advantages of this disclosure will become obvious and easy to understand from the description of the embodiments in conjunction with the following drawings.

FIG. 1 is a schematic diagram an exemplary communication system consistent with various embodiments of the present disclosure.

FIG. 2 is a schematic structural diagram of an exemplary unmanned aerial vehicle.

FIG. 3 is a schematic structural diagram of an exemplary unmanned aerial vehicle consistent with various embodiments of the present disclosure.

FIG. 4 is a schematic structural diagram of another exemplary unmanned aerial vehicle consistent with various embodiments of the present disclosure.

FIG. 5 is a schematic structural diagram of another exemplary unmanned aerial vehicle consistent with various embodiments of the present disclosure.

FIG. 6 is a schematic diagram of an exemplary control link consistent with various embodiments of the present disclosure.

FIG. 7 is a flow chart of an exemplary testing method of a communication system consistent with various embodiments of the present disclosure.

FIG. 8 is a flow chart of another exemplary testing method of a communication system consistent with various embodiments of the present disclosure.

FIG. 9 is a flow chart of another exemplary testing method of a communication system consistent with various embodiments of the present disclosure.

FIG. 10A is a schematic diagram showing uplink packet loss consistent with various embodiments of the present disclosure.

FIG. 10B is a schematic diagram showing downlink packet loss consistent with various embodiments of the present disclosure.

FIG. 11A is a schematic diagram showing the delay of uplink and downlink consistent with various embodiments of the present disclosure.

FIG. 11B is a schematic diagram showing bandwidths consistent with various embodiments of the present disclosure.

FIG. 12 is a schematic structural diagram of an exemplary testing device of a communication system consistent with various embodiments of the present disclosure.

FIG. 13 is a schematic structural diagram of another exemplary testing device of a communication system consistent with various embodiments of the present disclosure.

### DETAILED DESCRIPTION OF THE EMBODIMENTS

Technical solutions of the present disclosure will be described with reference to the drawings. It will be appreciated that the described embodiments are part rather than all of the embodiments of the present disclosure. Other embodiments conceived by those having ordinary skills in the art on the basis of the described embodiments without inventive efforts should fall within the scope of the present disclosure.

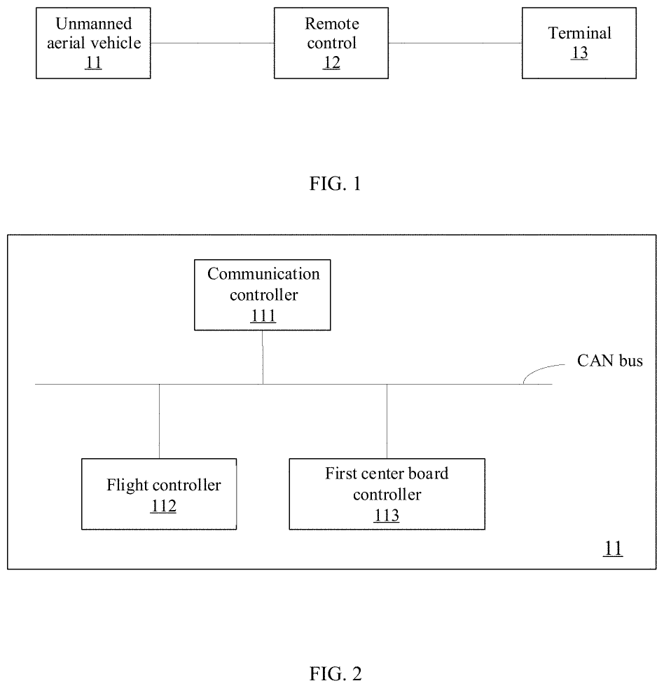

The present disclosure provides a communication system. As shown in FIG. 1, in one embodiment, the communication system includes an unmanned aerial vehicle 11 and a remote control 12. The remote control 12 is in communication connection with the unmanned aerial vehicle 11, and is used to control the unmanned aerial vehicle 11. Specifically, the remote control 12 can control flight attitude of the unmanned aerial vehicle 11 or control a load of the unmanned aerial vehicle 11. It should be noted that the remote control 12 and the unmanned aerial vehicle 11 can communicate directly or indirectly through a relay, which is not limited in the present disclosure.

Optionally, in another embodiment, the communication system may further include a terminal 13. The terminal 13 may be in communication connection with the remote control 12, and may communicate with the unmanned aerial vehicle 11 through the remote control 12. An application program (APP) of the terminal 13 may be used to control the unmanned aerial vehicle 11.

Generally, the unmanned aerial vehicle 11 may include a plurality of controllers. Specifically, the unmanned aerial vehicle 11 may include a communication controller, a flight controller, and/or a first center board controller. Among them, the communication controller may be used to receive control instructions from the remote control and send the control instructions to the flight controller or the first center board controller. For example, when a control instruction is a flight instruction used to control the flight attitude of the unmanned aerial vehicle 11, the flight instruction may be sent to the flight controller; when the control instruction is a flight instruction used to control the load of the unmanned aerial vehicle 11, the flight instruction may be sent to the first central board controller.

For example, as shown in FIG. 2, the communication controller 111, the flight controller 112 and the first center board controller 113 are electrically connected through a CAN bus. Specifically, the communication controller 111 receives a control instruction from the remote control 12, and sends the control instruction to the flight controller 112 or the first center board controller 113 via the CAN bus. Also, other data besides control commands between the controllers can also be transmitted through the CAN bus. For example, the communication controller 111 sends the upgrade data of the flight controller 112 to the flight controller 112 through the CAN bus. Data exchange between the first center board controllers 113 and the flight controller 112 is also achieved through the CAN bus. Since the communication between the communication controller 111, the flight controller 112, and the first center board controller 113 is based on the single CAN bus, there are problems of packet loss and large time delay in the CAN bus.

In the present disclosure, the communication controller 111 and the flight controller 112 can be electrically connected with the first center board controller 113 through a connection that is not based on the CAN bus, while the flight controller 112 and the first center board controller 113 are electrically connected via the CAN bus, to reduce the load on the CAN bus. Correspondingly, the packet loss and time delay on the CAN bus may be reduced.

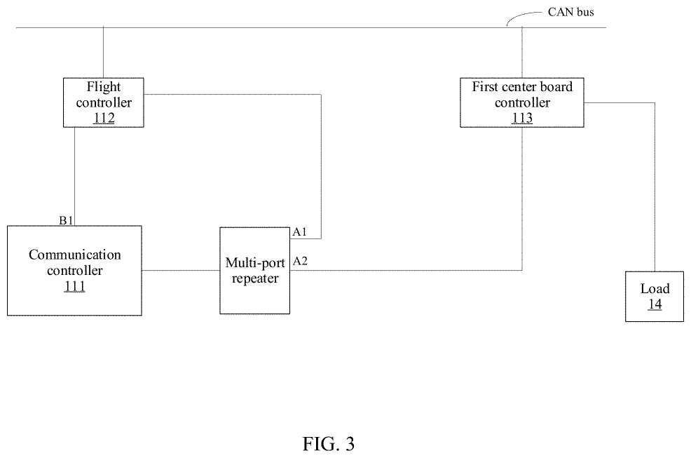

The present disclosure also provides an unmanned aerial vehicle. As shown in FIG. 3, in one embodiment, the unmanned aerial vehicle 11 includes a communication controller 111, a flight controller 112, and a first center board controller 113. The flight controller 112 and the first center board controller 113 are electrically connected via the CAN bus.

The communication controller 111 is electrically connected to the flight controller 112 through a first communication interface B1 and a first universal serial bus (USB) interface A1. The first communication interface B1 is used to transmit control instructions, and the first USB interface A1 is used to transmit upgrade data of the flight controller 112.

The communication controller 111 is configured to receive control instructions from the remote control 12, and transmit the control instructions to the first center board controller 113 or the flight controller 112. The remote control 12 is configured to control the unmanned aerial vehicle 11.

The first center board controller 113 is further electrically connected to a load 14 of the unmanned aerial vehicle 11, for forwarding the control instructions received from the communication controller 111 to the load 14.

The flight controller 112 is configured to control the unmanned aerial vehicle 11 according to the control instructions.

Data that needs to be exchanged between the flight controller 112 and the first center board controller 113 can be carried on the CAN bus. Data that needs to be exchanged between the communication controller 111 and the flight controller 112 can be carried on the first communication interface B1 and the first USB interface B1, that is, may not be carried on the CAN bus.

Considering that the flight controller 112 is used to control the unmanned aerial vehicle 11, users usually have higher control requirements for the unmanned aerial vehicle. In the present disclosure, the interaction between the communication controller 111 and the flight controller 112 can be made independent of the CAN bus. For description purposes only, the previous embodiment where the electrical connection between the first center board controller 113 and the communication controller 111 is based on the first communication interface B1 and the first USB interface B1, is used as an example to illustrate the present disclosure, and does not limit the scope of the present disclosure. For example, in some other embodiments, the first center board controller 113 and the communication controller 111 may be electrically connected via a CAN bus, or may be electrically connected based on another connection means other than the CAN bus.

Specifically, the communication controller 111, as the control core of the unmanned aerial vehicle 11, can control code stream transmission with the remote controller 12, and can also implement upgrade-related functions, for example, specifically can control the upgrade of the flight controller 112.

The control instructions sent by the remote control 12 may be used to control the unmanned aerial vehicle 11 or can also be used to control the load 14 of the unmanned aerial vehicle 11. Specifically, for the control instruction for controlling the unmanned aerial vehicle 11, after receiving the control instruction from the remote control 12, the communication controller 111 may send the control instruction to the flight controller 112 through the first communication interface B1, and the flight controller 112 may control the unmanned aerial vehicle 11 according to the control instructions. For the control instructions to control the load 14 of the unmanned aerial vehicle 11, after receiving the control instructions from the remote control 12, the communication controller 111 may send the control instructions to the first center board controller 113, and the first center board controller 113 may forward the control instructions to load 14. Further, for the upgrade data of the flight controller 112, the communication controller 111 may send the upgrade data to the flight controller 112 through the first USB interface A1.

Optionally, the communication between the communication controller 111 and the remote control 12 may be based on software defined radio (SDR). Specifically, SDR is based on a software-defined wireless communication protocol rather than a hard-wired implementation. The frequency band, air interface protocol and functions can be upgraded through software downloads and updates without completely replacing the hardware. In the present disclosure, the communication between the communication controller 111 and the remote control 12 may be based on SDR communication, providing flexibility in communication design.

Further optionally, the communication controller 111 may be a Lianxin LC1860 chip supporting SDR communication. Here, when the remote control 12 uses the SDR to communicate with the communication controller 111, the maximum uplink bandwidth can reach 12 kilobytes per second (KB/s).

Optionally, there may be one or more of the remote control 12 establishing communication connection with the unmanned aerial vehicle 11.

Optionally, the first center board controller 113 may be an M7 chip.

For description purposes only, the embodiment in FIG. 3 where the unmanned aerial vehicle 11 does not include the load 14 is used as an example to illustrate the present disclosure, and does not limit the scope of the present disclosure. For example, in other embodiments, the unmanned aerial vehicle 11 may include the load 14.

For description purposes only, the embodiment in FIG. 3 with the direct communication connection between the first center board controller 113 and the load 14 is used as an example to illustrate the present disclosure, and does not limit the scope of the present disclosure. For example, in other embodiments, the first center board controller 113 may communicate with the load 14 indirectly through other controllers.

For description purposes only, the embodiment in FIG. 3 where the first USB interface A1 is a communication interface of a multi-port repeater electrically connected to the communication controller 111 is used as an example to illustrate the present disclosure, and does not limit the scope of the present disclosure. For example, in other embodiments, when saving the interfaces of the communication controller 111 is not considered, the first USB interface A1 may also a communication interface in the communication controller 111.

In some embodiments, when saving the interfaces of the communication controller 111 is considered, the first USB interface A1 may be a communication interface of a multi-port repeater electrically connected to the communication controller 111.

The USB interface in the embodiment of the present disclosure may be specifically understood as an interface for communication based on the USB protocol. Moreover, fast performance is one of the outstanding features of the USB technology, and the use of the USB interface in the embodiment of the present disclosure may increase the transmission rate. At present, the highest transmission rate of the USB interface can reach 12 megabits per second (Mb/s), which is 100 times faster than the serial port and more than ten times faster than the parallel port.

In the present disclosure, the flight controller 112 and the first center board controller 113 may be electrically connected via the CAN bus. The communication controller 111 may be electrically connected to the flight controller 112 through the first communication interface B1 and the first USB interface A1. The first communication interface B1 may be used to transmit control instructions, and the first USB interface A1 may be used to transmit upgrade data of the flight controller 112. Correspondingly, the data that needs to be exchanged between the flight controller 112 and the first center board controller 113 can be carried on the CAN bus, and the data that needs to be exchanged between the communication controller 111 and the flight controller 112 can be carried on the first communication interface B1 and the first USB interface B1, that is, may not be carried on the CAN bus. The load of the CAN bus may be reduced. Correspondingly, the problem including packet loss and large time delay because of a large load on the CAN bus may be avoided. The packet loss and time delay of the CAN bus may be reduced.

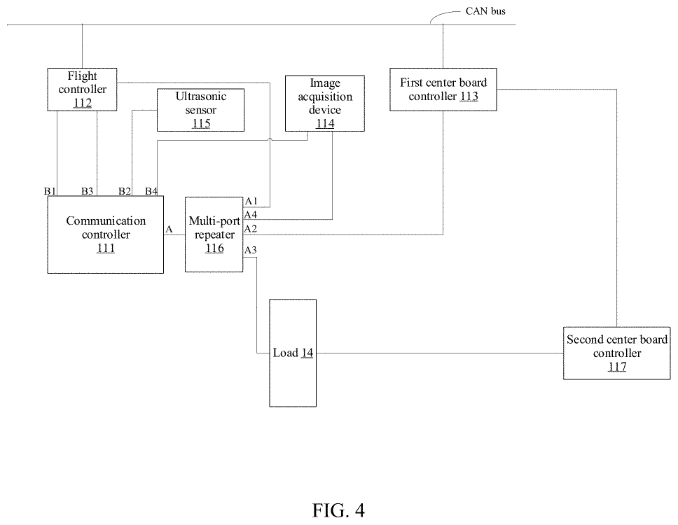

Another embodiment of the present disclosure also provides another unmanned aerial vehicle. As shown in FIG. 4, based on the embodiment in FIG. 3, in the unmanned aerial vehicle 11, the communication controller 111 and the first center board controller 113 are electrically connected through an implementation method. As shown in FIG. 4, optionally, the communication controller 111 and the first center board controller 113 are electrically connected through a second USB interface A2, for transmitting at least one of upgrade data (upgrade data for the first center board controller 113), log content, or controller instructions.

Specifically, the communication controller 111 may send upgrade data to the first center board controller 113 through the second USB interface A2, and the first center board controller 113 may perform software upgrades according to the received upgrade data; and/or the communication controller 111 may send a control instruction to the first center board controller 113 through the second USB interface A2, and the first center board controller 113 may forward the received control instruction to the load 14; and/or the first center board controller 113 may receive the log content sent by the load 14, and send the log content to the communication controller 111 through the second USB interface A2.

For description purposes only, the embodiment in FIG. 4 where the second USB interface A2 is a communication interface of a multi-port repeater electrically connected to the communication controller 111 is used as an example to illustrate the present disclosure, and does not limit the scope of the present disclosure. For example, in other embodiments, when saving the interfaces of the communication controller 111 is not considered, the second USB interface A2 may also a communication interface in the communication controller 111.

In the present embodiment, the communication controller 111 may be electrically connected to the first center board controller 113 through the second USB interface A2, further reducing the load of the CAN bus.

Optionally, the unmanned aerial vehicle may send image data acquired by the load to the remote control, that is, realize image transmission. Further, to further reduce the load of the CAN bus, as shown in FIG. 4, the communication controller 111 is electrically connected to the load 14 through a third USB interface A3 for image data transmission.

Optionally, the load 14 may include at least one of a camera controller, a first camera, or a second camera. For description purposes only, the embodiments with maximally two cameras are used as examples to illustrate the present disclosure, and do not limit the scope of the present disclosure.

The camera controller can be used to encode the image data obtained by the camera. Optionally, the communication controller 111 may obtain encoded image data from the camera controller through the third USB interface A3, or may obtain unencoded image data from the camera through the third USB interface A3.

Optionally, the communication controller 111 may send upgrade data to the load 14 through the third USB interface A3, and the load 14 performs software upgrades according to the received upgrade data.

For description purposes only, the embodiment in FIG. 4 where the third USB interface A3 is a communication interface of a multi-port repeater electrically connected to the communication controller 111 is used as an example to illustrate the present disclosure, and does not limit the scope of the present disclosure. For example, in other embodiments, when saving the interfaces of the communication controller 111 is not considered, the third USB interface A3 may also a communication interface in the communication controller 111.

Optionally, the unmanned aerial vehicle 11 may include an image acquisition device 114, and the communication controller 111 may implement control of the image acquisition device 114. To further reduce the load of the CAN bus, as shown in FIG. 4, optionally, the communication controller 111 may be electrically connected to the image acquisition device 114 through a fourth USB interface A4 for transmitting control commands. It should be noted that the control instruction here may specifically be a control instruction sent by a remote control.

The image acquisition device 114 may include a controller and an image sensor. Specifically, the communication controller 111 may send a control instruction to the controller provided in the image acquisition device 114 through the fourth USB interface A4. Further, the controller of the image acquisition device 114 may control the image sensor to capture images according to the received control instruction. In one embodiment, the controller of the image processing device 114 may be, for example, an MA2155 chip.

Optionally, the image sensor provided in the image acquisition device 114 may specifically be a first person view camera.

Further optionally, the image acquisition device 114 may send the captured image data to the communication controller 111, such that the communication controller 111 sends the acquired image data to the terminal through the remote control.

For description purposes only, the embodiment in FIG. 4 where the fourth USB interface A4 is a communication interface of a multi-port repeater electrically connected to the communication controller 111 is used as an example to illustrate the present disclosure, and does not limit the scope of the present disclosure. For example, in other embodiments, when saving the interfaces of the communication controller 111 is not considered, the fourth USB interface A4 may also a communication interface in the communication controller 111.

Optionally, the communication controller may include an ultrasonic sensor 115, and the communication controller 111 may implement upgrade control of the ultrasonic sensor 115. To further reduce the load of the CAN bus, as shown in FIG. 4, optionally, the communication controller 111 may be electrically connected to the ultrasonic sensor 115 through a second communication interface B2 for transmitting upgrade data of the ultrasonic sensor 115. Specifically, the communication controller 111 may send upgrade data to the ultrasonic sensor 115 through the second communication interface B2. Further, the ultrasonic sensor 115 may perform software upgrades according to the received upgrade data. In one embodiment, the ultrasonic sensor 115 may be an ultrasonic MO chip, for example.

Optionally, the communication controller 111 may implement the navigation system function of the unmanned aerial vehicle 11. To further reduce the load of the CAN bus, as shown in FIG. 4, optionally, the communication controller 111 may be electrically connected to the flight controller 112 through a third communication interface B3 for transmitting navigation related data. Specifically, the communication controller 111 may send navigation related data to the flight controller 112 through the third communication interface B3. Further, the flight controller 112 may perform flight control according to the received navigation related data. The navigation related data may include current latitude and longitude coordinates, for example.

Optionally, the communication controller 111 may control the functions of the image acquisition device 114. To further reduce the load of the CAN bus, as shown in FIG. 4, further optionally, the communication controller 111 may be electrically connected to the image acquisition device 114 through a fourth communication interface B4, for transmitting firmware data of the image acquisition device 114. Specifically, the communication controller 111 can send firmware data to the controller of the image acquisition device 114 through the fourth communication interface B4. Further, the controller of the image acquisition device 114 can write the received firmware data into a programmable read-only memory in the image acquisition device 114.

Optionally, the image acquisition device 114 may communicate with the ultrasonic sensor 115. Further optionally, the image acquisition device 114 may be electrically connected to the ultrasonic sensor 115 through a serial peripheral interface (SPI) serial port. For example, the image acquisition device 114 may obtain the measurement data measured by the ultrasonic sensor from the ultrasonic sensor 115, and perform data fusion between the measurement data measured by the image acquisition device 114 and the measurement data measured by the ultrasonic sensor.

Optionally, the fourth communication interface B4 may be an SPI serial port.

Optionally, at least one of the first communication interface, the second communication interface, and the third communication interface may be asynchronous. Further optionally, at least one of the first communication interface, the second communication interface, and the third communication interface may be a universal asynchronous receiver/transmitter (UART) interface.

Optionally, as shown in FIG. 4, the communication controller 111 may be provided with a USB interface A. The USB interface A may be electrically connected to the first USB interface A1, the second USB interface A2, the third USB interface A3, and the fourth USB interface A4 through a multi-port repeater 116. By providing the multi-port repeater 116, the first USB interface A1, the second USB interface A2, the third USB interface A3, and the fourth USB interface A4 can share one USB interface of the communication controller 111, that is, the USB interface A, saving the interface of the communication controller.

Optionally, the multi-port repeater may be a hub.

Optionally, the multi-port repeater may have four ports.

When the number of ports of the multi-port repeater is too large, the implementation is too complicated. Optionally, in one embodiment, a plurality of the multi-port repeaters 116 may be provided, and the plurality of multi-port repeaters 116 may be connected in a cascaded way. The USB interface A may be electrically connected to a first stage multi-port repeater of the plurality of multi-port repeaters 116. Each of the plurality of multi-port transponders 116 can be used as one of the first USB interface A1, the second USB interface A2, the third USB interface A3, or the fourth USB interface A4.

In addition to forwarding the received control instructions to the load 14, the first center board controller 113 may also implement other functions. Optionally, the first center board controller 113 may be used to implement power management of the unmanned aerial vehicle 11. Further optionally, when the first center board controller 113 communicates with the load 14, the first center board controller 113 may use a communication protocol different from a communication protocol used by the load 14.

Further, a second center board controller 117 may be connected between the first center board controller 113 and the load 14. The second center board controller 117 may interact with the load 14 based on a first communication protocol, and interact with the first center board controller 113 based on a second communication protocol. The second center board controller 117 may be used to implement software adaptation of the conversion between the first communication protocol and the second communication protocol. Optionally, the second center board controller 117 may be electrically connected to the communication controller 112 through the first center board controller 113 by a CAN bus. It should be noted that the CAN bus here is different from the CAN bus that realizes the electrical connection between the flight controller 112 and the first center board controller 113.

The first communication protocol may be, for example, a CAN protocol, and the second communication protocol may be, for example, an SPI protocol. Optionally, when the first communication protocol is the CAN protocol and the second communication protocol is the SPI protocol, the second center board controller 117 can be replaced with a protocol conversion chip that can convert the SPI protocol to the CAN protocol, such as the MCP25625 chip.

Optionally, the load 14 electrically connected to the second center board controller 117 may include at least one of the following: a first gimbal, a second gimbal, a first camera, a second camera, or a camera controller. The first gimbal may be electrically connected to the first camera, the second gimbal may be electrically connected to the second camera, and the camera controller may be electrically connected to the second center board controller 117.

Further optionally, when the load 14 includes the first pan-tilt and the second pan-tilt, the second center board controller 117 may be an M4 chip. It should be noted that when the load includes the first gimbal and the second gimbal, the first center board controller 113 and the second center board controller 117 can be connected through two pairs of interfaces. The two pairs of interfaces and the two gimbals may have a one-to-one correspondence relationships.

Further optional, considering that a gimbal needs to use a bandwidth of about 30 KB/s to push log content and open, to ensure a certain margin in the link design, the two pairs of interfaces between the first center board controller 113 and the second center board controller 117 may respectively use a baud rate of 921600, and the maximum can reach 92.16 KB/s. If the baud rate of 115200 is adopted, it will cause the overload of the link and cause serious packet loss.

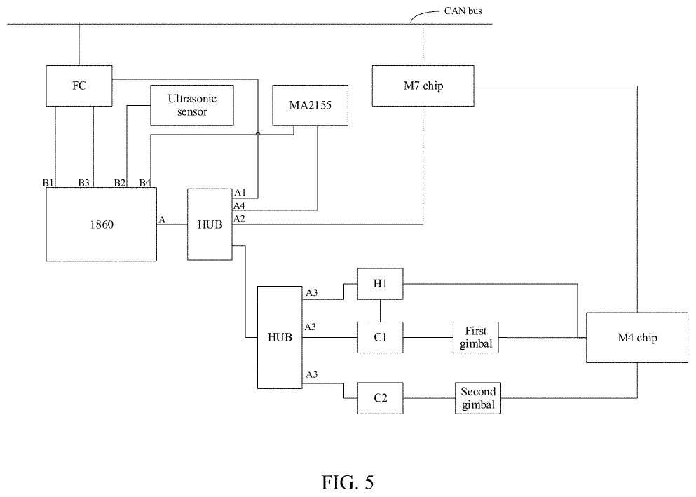

Another embodiment shown in FIG. 5 provides another unmanned aerial vehicle. Based on the unmanned aerial vehicle in previous embodiments, the present embodiment will mainly describe the detailed structure of the unmanned aerial vehicle. As shown in FIG. 5, the unmanned aerial vehicle includes two multi-port repeaters 116, and the load 14 electrically connected to the communication interface 111 through the third USB interface A3 includes the camera controller H1, the first camera C1, and the second camera C2.

As shown in FIG. 5, the load 14 electrically connected to the 1860 chip of the communication controller through the M7 chip and M4 chip of the first center board controller, includes H1, C1, C2, the first gimbal M7 is electrically connected to C1, and the second gimbal electrically connected to C2.

When the 1860 chip receives the control instruction sent by the remote control 12 for controlling the first pan-tilt, the 1860 chip may send the control instruction to the M7 chip through the second USB interface A2, and the M7 chip may forward the control instruction to the M4 chip based on the second communication protocol. The M4 chip may forward the control instruction to the first pan-tilt based on the first communication protocol.

It should be noted that the first pan-tilt in FIG. 5 may forward the control instruction for controlling C1 to C1, and the second pan-tilt may forward the control instruction for controlling C2 to C2.

Optionally, in FIG. 5, the M4 chip may be electrically connected to the first pan-tilt and the second pan-tilt based on the CAN bus. A too large communication rate of the CAN bus will cause the interval of in and out interruption in the communication process to be reduced. A too small communication rate of the CAN bus will cause the overload of the link and cause serious packet loss. The communication speed of the CAN bus can be 1 Mbps, and the maximum bandwidth flow of 72 KB/s can be supported.

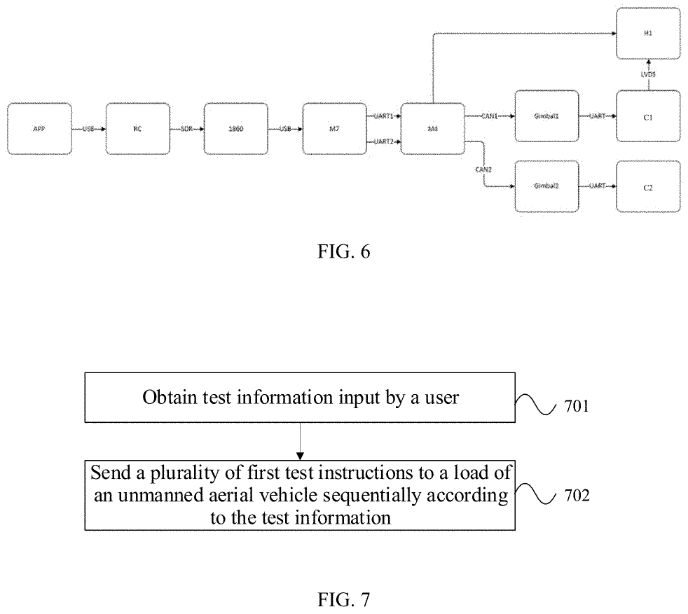

Further optionally, based on the structure of the unmanned aerial vehicle shown in FIG. 5, the control link of the gimbals and cameras may be as shown in FIG. 6.

The present disclosure also provides a communication system. The communication system may include a remote control 12, and an unmanned aerial vehicle 11 provided by various embodiments of the present disclosure. Optionally, the communication system may further include a terminal 13.

Based on the communication system provided by various embodiments, the present disclosure also provides a communication system testing method, which can be applied to the terminal 13 in the communication system. As shown in FIG. 7, in one embodiment, the communication system testing method includes processes 701 and 702.

At 701, test information input by a user is obtained.

Optionally, an interface for setting test information can be provided to the user in the APP of the terminal, and the user can input the test information in the interface. The test information may be used to test the communication link (ie, the uplink) from the terminal 13 to the unmanned aerial vehicle 11 through the remote control 12. The test information can be used to indicate a specific test method for testing the uplink.

Optionally, the test information may include one or more of a transmission time length of the test instruction, a transmission frequency of the test instruction, or a length of the test instruction. It should be noted that when testing a link, it is usually necessary to send a test instruction with a certain length at a certain frequency within a period of time. The period of time may specifically be the transmission time length of the above-mentioned test instruction, the certain frequency may specifically be the transmission frequency of the above-mentioned test command, and the certain length may specifically be the length of the above-mentioned test command. When a certain item is not included in the test information, this item can be regarded as a default item. For example, when the transmission time length is not included in the test information, the transmission time length can be defaulted to be 30 minutes.

At 702, a plurality of first test instructions are sent to the load of the unmanned aerial vehicle sequentially according to the test information.

Each first test instruction of the plurality of first test instructions includes a first sequence number and a first time stamp indicating the sending time, and the first sequence number is sequentially accumulated according to the sending order. The first time stamp may be used to determine the delay of the uplink, and the first sequence number may be used to determine the packet loss of the uplink.

Specifically, the delay of the first test instruction can be determined according to the time when the unmanned aerial vehicle receives the first test instruction and the first time stamp included in the first test instruction. For example, when the receiving time of the first test command is 11:29:20 on Nov. 28, 2018 and the first time stamp included in the first test command is 11:29:19 on Nov. 28, 2018, it can be determined that the delay of the first test instruction is 1 second.

Specifically, the uplink packet loss can be determined according to the first sequence numbers respectively included in the plurality of first test instructions received by the unmanned aerial vehicle. For example, if the unmanned aerial vehicle receives the plurality of first test instructions, and the first sequence numbers included in the plurality of first test instructions are 1, 3, 4, 5, 6, and 7, it can be determined that a packet loss problem occurred in one first test instruction with the first sequence number of 2 of the plurality of first test instructions.

Each first test instruction of the plurality of first test instructions is an instruction that needs to be sent by the terminal 13 to the load 14 of the unmanned aerial vehicle 11 through the remote control 12. It can be seen from FIG. 3 that the plurality of first test instructions can be sent to the load 14 via the communication controller 111 and the first center board controller 113 inside the unmanned aerial vehicle 11. It can be seen in combination with FIG. 4 and FIG. 5 that the plurality of first test instructions can be sent to the load 14 via the communication controller 111, the first center board controller 113 and the second center board controller 117 inside the unmanned aerial vehicle 11.

In the present disclosure, the test information input by the user may be obtained, and then the plurality of first test instructions may be sent to the load of the unmanned aerial vehicle sequentially according to the test information. Each first test instruction of the plurality of first test instructions may include a first sequence number and a first time stamp indicating the sending time, and the first sequence number may be sequentially accumulated according to the sending order. Correspondingly, the uplink test may be completed according to the plurality of first test instructions sent by the terminal of the unmanned aerial vehicle to the unmanned aerial vehicle. Compared to using hardware tools and upper computer software to assist in link testing in the existing technologies, limitations of the test may be reduced. Specifically, when the hardware tools and host computer software are used to assist in link testing, a fixed station, special tools and specialists are required for testing, and the test can only be performed when the unmanned aerial vehicle is not flying. Correspondingly, the test can only be applied to the whole machine test when it leaves the factory. The test method provided by the present disclosure can be used to test the unmanned aerial vehicle when the unmanned aerial vehicle is flying or not flying, and the test can be performed without a fixed station, special tools, or a specialist.

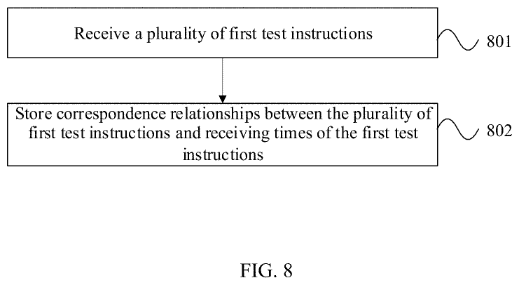

The present disclosure also provides another communication testing method, which can be applied to the unmanned aerial vehicle 11 of the communication system. As shown in FIG. 8, the testing method provided by the present embodiment includes S801 and S802.

At S801, a plurality of first test instructions is received.

Each first test instruction of the plurality of first test instructions may include a first sequence number and a first time stamp indicating the sending time, and the first sequence number may be sequentially accumulated according to the sending order. In one embodiment, S801 may specifically include: receiving the plurality of first test instructions sequentially. It should be noted that the order of receiving the plurality of first test instructions at S801 may be same as or different from the order of the first sequence number included in the plurality of first test instructions, which is not limited in the present disclosure. For example, a first test instruction with the first sequence number 1 may be received first, and then a first test instruction with the first sequence number 3 is received, and then a first test instruction with the first sequence number 2 is received.

The plurality of first test instructions may be instructions sent by the terminal 13 to the load 14 of the unmanned aerial vehicle 11 through the remote control 12. Therefore, anyone or more controllers used for forwarding to the load 14 in the unmanned aerial vehicle can receive the plurality of first test instructions. In one embodiment, as shown in FIG. 3, it can be seen that the controllers within the unmanned aerial vehicle 11 that can receive the plurality of first test instructions may include one or more of the communication controller 111 or the first center board controller 113. In another embodiment shown in FIG. 4 and FIG. 5, it can be seen that the controllers inside the unmanned aerial vehicle 11 that can receive the first control instruction may include one or more of the communication controller 111, the first center board controller 113, or the second center board controller 117.

At S802, correspondence relationships between the plurality of first test instructions and receiving times of the first test instructions are saved.

Optionally, the correspondence relationships between the plurality of first test instructions and the receiving times of the first test instructions may be stored in a specific file, for example, a text file, an Excel file, etc. Specifically, anyone or more controllers in the unmanned aerial vehicle that forward the first test instruction, for example, the first center board controller, the second center board controller, etc, may store the correspondence relationships between the first test instructions and the times when the controller receives the first test instructions.

Since the first test instruction includes the first time stamp and the first sequence number, the uplink link state can be obtained based on the correspondence relationships stored by the unmanned aerial vehicle, thereby realizing the uplink test.

It should be noted that the specific manner of storing the correspondence relationships between the first test instructions and the receiving times of the first test instructions is not limited in the present disclosure. For example, in one embodiment, the first test instruction and the receiving time of the first test instruction may be correspondingly stored in the form of a table.

In the present disclosure, the plurality of first test instructions may be received, and then the correspondence relationships between the plurality of first test instructions and the receiving times of the first test instructions may be saved. Since the first test instruction includes the first time stamp and the first sequence number, the uplink link state can be obtained based on the correspondence relationships stored by the unmanned aerial vehicle, thereby realizing the uplink test.

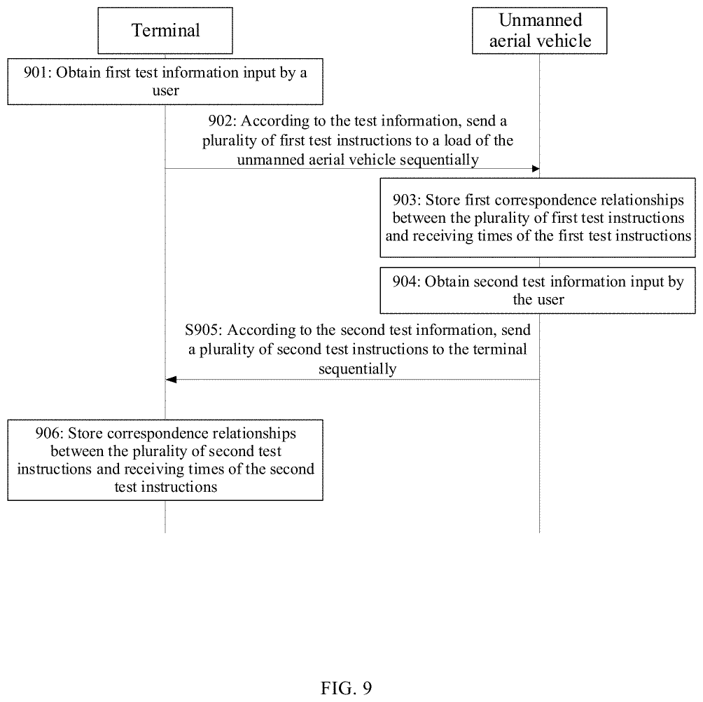

The present disclosure also provides another communication system testing method. As shown in FIG. 9, based on the communication testing method in FIG. 7 and FIG. 8, the communication system testing method of the present embodiment mainly illustrates the interaction between the terminal 13 and the unmanned aerial vehicle 11. As shown in FIG. 9, the communication system testing method includes processes 901 to 903.

At 901, the terminal receives first test information inputted by a user.

The first test information may include one or more of a transmission time length of the test instruction, a transmission frequency of the test instruction, or a length of the test instruction.

For the details of process 901, reference can be made to the description of process 701.

At 902, the terminal sends a plurality of first test instructions to the load of the unmanned aerial vehicle sequentially according to the first test information.

Each first test instruction of the plurality of first test instructions includes a first sequence number and a first time stamp indicating the sending time, and the first sequence number is sequentially accumulated according to the sending order.

For the details of process 902, reference can be made to the description of process 702.

At 903, the unmanned aerial vehicle saves first correspondence relationships between the plurality of first test instructions and receiving times of the first test instructions.

Since the first time stamp in the first test instruction can be used to determine the delay parameter, the first sequence number in the first test instruction can be used to determine the packet loss parameter. Optionally, when testing the uplink packet loss parameters and delay parameters, process 903 may specifically include: storing first correspondence relationships between the first time stamps and the first serial numbers of the plurality of first test instructions, and the receiving times of the first test instructions.

Further optionally, in the storing process, the first correspondence relationships between the plurality of first test instructions and the receiving times of the first test instructions may be sequentially stored according to the receiving order of the plurality of first test instructions. According to the receiving order of the plurality of first test instructions, the correspondence relationships between the plurality of first test instructions and the receiving times of the first test instructions is sequentially stored. Correspondingly, the determination of the uplink test result based on the correspondence relationships may be facilitated. For example, in one embodiment, the first center board controller first receives a first test instruction a at time 1, then receives a first test instruction b at time 2, and then receives a first test instruction c at time 3. Correspondingly, the first correspondence relationships can be stored in a form shown in Table 1 below.

TABLE 1

| Receiving time | Time stamp | Sequence number |
|---|---|---|
| Time 1 | a1 | a2 |
| Time 2 | b1 | b2 |
| Time 3 | c1 | c2 |

In Table 1, a1 represents the first time stamp of the first test command a, a2 represents the first sequence number of the first test command a; b1 represents the first time stamp of the first test command b, and b2 represents the first sequence number of the first test command b; c1 represents the first time stamp of the first test instruction c, and c2 represents the first serial number of the first test instruction c.

Optionally, the test result may be determined according to the plurality of first test instructions received by the unmanned aerial vehicle. Specifically, anyone or more controllers in the unmanned aerial vehicle that forward the plurality of first test instructions may determine the test result according to the plurality of first test instructions. For example, the test result may be determined by the above-mentioned first center board controller or the second central board controller according to the plurality of first test instructions.

Optionally, in one embodiment, after process 903, the method may further include: according to the stored first correspondence relationship, determining the receiving time of each of the plurality of first test instructions and the first time stamp included in each of the plurality of first test instructions; and according to the receiving time of each of the plurality of first test instructions and the first time stamp included in each of the plurality of first test instructions, determining the delay parameter. Optionally, the delay parameter may include one or more of an average delay or a maximum delay, etc.

Optionally, in one embodiment, after process 903, the method may further include: according to the stored first correspondence relationship, determining the first sequence number included in each of the plurality of first test instructions; and determining the packet loss parameter according to the first sequence number included in each of the plurality of first test instructions. Optionally, the packet loss parameter may include a packet loss rate and/or a packet loss amount, etc.

In some other embodiments, a device other than the unmanned aerial vehicle may be used to determine the test result.

Optionally, the communication link from the unmanned aerial vehicle 11 to the terminal 13 can be tested. Correspondingly, the testing method may further include processes 904 to 906. It should be noted that there is no restriction on the sequence between processes 904 to 906 and processes 901 to 903.

At 904, the unmanned aerial vehicle obtains second test information input by a user.

Optionally, any one or more controllers in the unmanned aerial vehicle used to forward the control instructions sent by the remote control to the load 14 may obtain the second test information input by the user. The second test information can be used to test the communication link (ie, downlink) from the unmanned aerial vehicle 11 to the terminal 13 through the remote control 12. The second test information may be used to indicate a specific test method for testing the downlink.

Optionally, at least one of the second center board controller or the first center board controller may obtain the second test information input by the user.

Optionally, the second test information includes one or more of a transmission time length of the test instruction, a transmission frequency of the test instruction, or length of the test instruction.

At 905, the unmanned aerial vehicle sends a plurality of second test instructions to the terminal sequentially according to the second test information.

Each second test instruction of the plurality of second test instructions includes a second sequence number and a second time stamp indicating the sending time, and the second sequence number is sequentially accumulated according to the sending order. Specifically, any one or more controllers in the unmanned aerial vehicle used to forward the control instructions sent by the remote control to the load 14 may be used to send the plurality of second test instructions to the terminal sequentially according to the second test information.

The detailed process for the unmanned aerial vehicle to send the plurality of second test instructions to the terminal sequentially according to the second test information may be similar to the process for the terminal to send the plurality of first test instructions to the load of the unmanned aerial vehicle sequentially according to the first test information.

At 906, the terminal stores second correspondence relationships between the plurality of second test instructions and receiving times of the second test instructions.

Similar to the process for the unmanned aerial vehicle to store the first correspondence relationships, process 906 may specifically include: storing the second correspondence relationships between the second time stamps and the second sequence numbers of the plurality of second test instructions and the receiving times of the second test instruction. Further optionally, storing the second correspondence relationships between the plurality of second test instructions and the receiving times of the second test instructions may include: according to the receiving order of the plurality of second test instructions, sequentially storing the correspondence relationships between the plurality of second test instructions and the receiving times of the second test instructions.

Optionally, in one embodiment, after process 906, the method may further include: according to the stored second correspondence relationship, determining the receiving time of each of the plurality of second test instructions and the second time stamp included in each of the plurality of second test instructions; and according to the receiving time of each of the plurality of second test instructions and the second time stamp included in each of the plurality of second test instructions, determining the delay parameter.

In addition or alternatively, in one embodiment, after process 906, the method may further include: according to the stored second correspondence relationship, determining the second sequence number included in each of the plurality of second test instructions; and determining the packet loss parameter according to the second sequence number included in each of the plurality of second test instructions.

In the present disclosure, the terminal may send the plurality of first test instructions to the unmanned aerial vehicle according to the first test information input by the user, and the unmanned aerial vehicle may store the first correspondence relationships between the plurality of first test instructions and the receiving times of the first test instructions. The unmanned aerial vehicle may send the plurality of second test instructions to the terminal sequentially according to the second test information, and the terminal may store the second correspondence relationships between the plurality of second test instructions and the receiving times of the second test instructions. The test of the uplink and the downlink may be achieved.

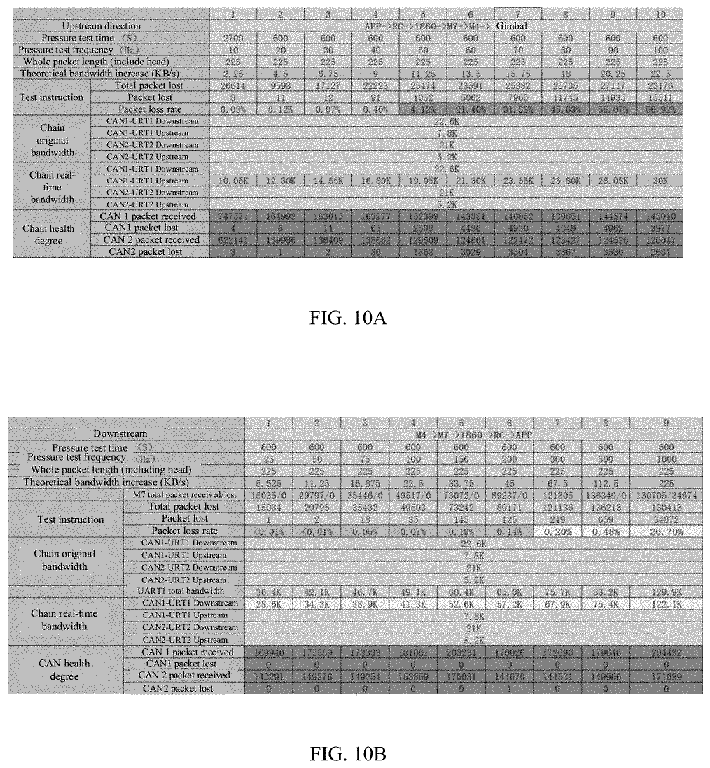

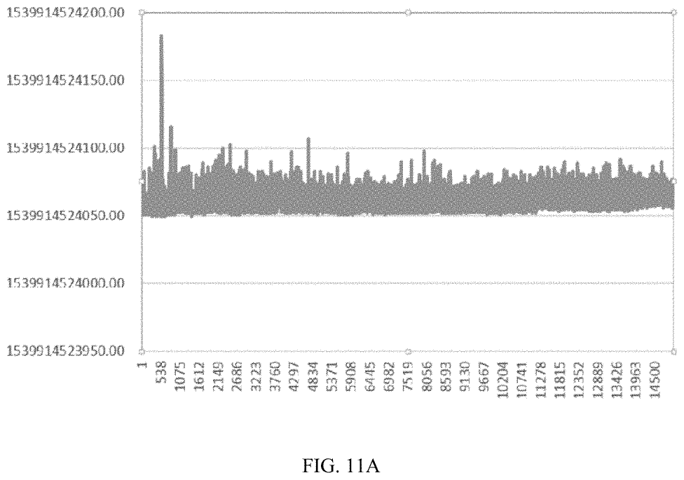

Based on FIG. 5 or FIG. 6, the test results of the uplink loss of APP->RC->1860->M7->M4->PTZ are shown in FIG. 10A. Based on the analysis of FIG. 10A, it can be seen that because of the unstable state when the unmanned aerial vehicle is started, the packet loss of the first 4 sets of data is mostly caused by unstable factors at the start. There is still a stable margin of about 10K in the uplink, and if the uplink load is increased, the packet loss rate will increase exponentially and affect the CAN reception of the gimbal. Therefore, the bandwidth of the SDK can be limited to 12K.

Based on FIG. 5 or FIG. 6, the test results for the downlink packet loss of M4->M7->1860->RC->APP are as shown in FIG. 10B. During the test conditions, data traffic is controlled to increase at the M4, and then the test instructions are received at the AAP. When the test instructions have packet loss phenomenon, the packet loss rate can be obtained. Based on the analysis of FIG. 10B, it can be seen that the downstream bandwidth margin is sufficient, no packet loss occurs through the serial port between M4 and M7, and the link packet loss rate is low.

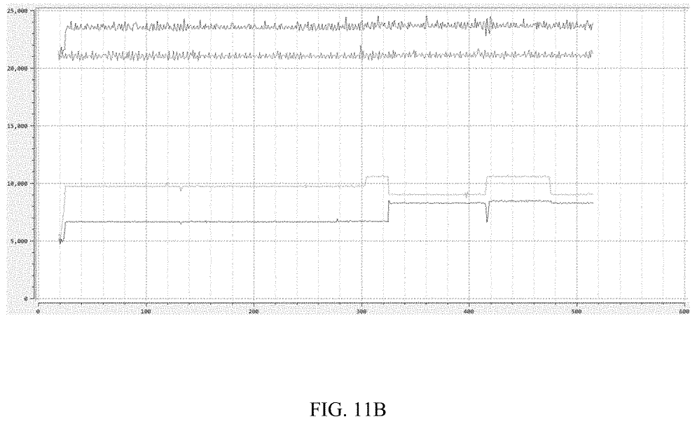

Based on FIG. 5 or FIG. 6, for APP->RC->1860->M7->M4->PTZ uplink, and M4->M7->1860->RC->APP downlink, when stress testing 6K data (that is, additional data of 6 KB/S to the link for a stress test, namely, observing when the problem of packet loss and delay is observed under what bandwidth condition is reached), the test result of the delay situation can be shown in FIG. 11A. It should be noted that the horizontal axis of FIG. 11A represents the serial number of the test instruction, and the vertical axis represents the time difference in milliseconds (ms).

Based on FIG. 5 or FIG. 6, the test results of the bandwidth of the two uplinks from APP to the camera C1 and the camera C2 in FIG. 6 and the two downlinks from the camera C1 and the camera C2 to APP can be shown in FIG. 11B. in FIG. 11B, the upper two lines correspond to the bandwidth flow values of the two gimbal cameras down transferred to the APP, and the lower two lines correspond to the bandwidth flow values of the control commands sent by the APP to the upstream channel. In FIG. 11B, the horizontal axis represents time, and the horizontal axis of represents bandwidth, in bytes/second (Byte/s).

The present disclosure also provides a computer-readable storage medium. The computer-readable storage medium may be configured to store program instructions. When the program instructions are executed, a portion or all of a communication system testing method provided by various embodiments of the present disclosure may be achieved.

The present disclosure also provides a computer program. When the computer program is executed, a communication system testing method provided by various embodiments of the present disclosure may be achieved.

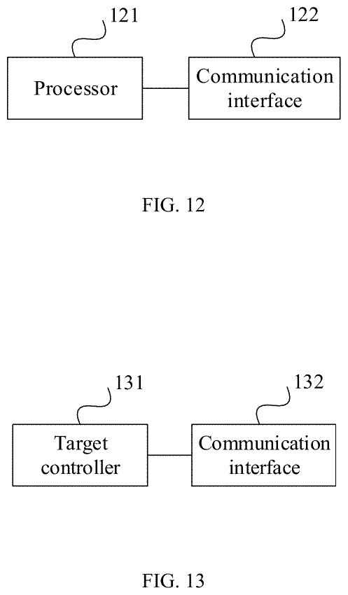

The present disclosure also provides a communication system test device. The communication system test device can be applied to the terminal of the communication system provided by various embodiments of the present disclosure. As shown in FIG. 12, in one embodiment, the communication system test device includes a processor 121 and a communication interface 122.

The processor 121 is configured to obtain test information input by a user.

The processor 121 is further configured to: according to the test information, send a plurality of first test instructions to a load of an unmanned aerial vehicle through the communication interface 122. Each first test instruction of the plurality of first test instructions includes a first sequence number and a first time stamp indicating the sending time, and the first sequence number is sequentially accumulated according to the sending order.

The test information may include one or more of a transmission time length of the test instruction, a transmission frequency of the test instruction, or a length of the test instruction.

Optionally, the processor 121 may be further configured to: receive a plurality of second test instructions from the unmanned aerial vehicle through the communication interface 122, and store correspondence relationships between the plurality of second test instructions and receiving times of the second test instructions.

Each second test instruction of the plurality of second test instructions includes a second sequence number and a second time stamp indicating the sending time, and the second sequence number is sequentially accumulated according to the sending order.

Optionally, when the processor 121 is configured to store the correspondence relationships between the plurality of second test instructions and the receiving times of the second test instructions, the processor 121 may be specifically configured to: store correspondence relationships between the second time stamps and the second sequence numbers of the plurality of second test instructions and the receiving times of the second test instructions.

Further optionally, when the processor 121 is configured to store the correspondence relationships between the plurality of second test instructions and the receiving times of the second test instructions, the processor 121 may be specifically configured to: according to the receiving order of the plurality of second test instructions, sequentially store the correspondence relationships between the plurality of second test instructions and the receiving times of the second test instructions.

Optionally, the processor 121 may be further configured to: according to the stored second correspondence relationship, determine the receiving time of each of the plurality of second test instructions and the second time stamp included in each of the plurality of second test instructions; and according to the receiving time of each of the plurality of second test instructions and the second time stamp included in each of the plurality of second test instructions, determine the delay parameter.

Optionally, the processor 121 may be further configured to: according to the stored second correspondence relationship, determine the second sequence number included in each of the plurality of second test instructions; and determine the packet loss parameter according to the second sequence number included in each of the plurality of second test instructions.

The communication system test device provided by various embodiments of the present disclosure may be used to execute the communication system test method of the terminal provided by the present disclosure.

Another embodiment of the present disclosure provides another communication system test device, as shown in FIG. 13. In the present embodiment, the communication system test device can be applied to an unmanned aerial vehicle of the communication system. As shown in FIG. 13, the communication system test device includes a target controller 131 and a communication interface 132. The target controller 131 is a controller that forwards the control instructions from the remote control to the load in the unmanned aerial vehicle. The remote control is used to control the unmanned aerial vehicle.

The target controller 131 is configured to receive a plurality of first test instructions through the communication interface 132. Each first test instruction of the plurality of first test instructions includes a first sequence number and a first time stamp indicating the sending time, and the first sequence number is sequentially accumulated according to the sending order.

The target controller 131 is further configured to store correspondence relationships between the plurality of first test instructions and the receiving times of the first test instructions.

Optionally, when the target controller 131 is configured to store the correspondence relationships between the plurality of first test instructions and the receiving times of the first test instructions, the target controller 131 may be specifically configured to: store correspondence relationships between the first time stamps and the first sequence numbers of the plurality of first test instructions and the receiving times of the first test instructions.

Optionally, when the target controller 131 is configured to store the correspondence relationship between the plurality of first test instructions and the receiving times of the first test instructions, the target controller 131 may be specifically configured to: according to the receiving order of the plurality of first test instructions, sequentially store the correspondence relationships between the plurality of first test instructions and the receiving times of the first test instructions.

Optionally, the target controller 131 may be further configured to: determine the time delay parameters according to the receiving time of each of the plurality of first test instructions and the first time stamp of each of the plurality of first test instructions.

Optionally, the target controller 131 may be further configured to determine the packet loss parameter according to the first sequence number of each of the plurality of first test instructions.

Optionally, the target controller 131 may be further configured to: obtain test information input by a user; and send a plurality of second test instructions to a terminal sequentially through the communication interface 132 according to the test information.

Each second test instruction of the plurality of second test instructions includes a second sequence number and a second time stamp indicating the sending time, and the second sequence number is sequentially accumulated according to the sending order.

The test information may include one or more of a transmission time length of the test instruction, a transmission frequency of the test instruction, or a length of the test instruction.

Optionally, the target controller 131 may include one or more of a first center board controller or a communication controller.

Optionally, the first center board controller may be configured to implement the power supply management of the unmanned aerial vehicle, and a second center board controller may be connected between the first center board controller and the load.

The second center board controller may interact with the load based on a first communication protocol, and interact with the first center board controller based on a second communication protocol.

The second center board controller may be used to implement software adaptation for conversion between the first communication protocol and the second communication protocol.

The target controller 131 may further include the second center board controller.

The communication system test device consistent with the disclosure can be used to implement the technical solutions for the terminal in the foregoing method embodiments of the present disclosure. The implementation principles and technical effects are similar to those of the method embodiments described above, and will not be repeated here.

The present disclosure also provides a communication system test system, which includes the communication system test device described above in connection with FIG. 12 and the communication system test device described above in connection with FIG. 13.

A person of ordinary skill in the art can understand that all or part of the processes in the above-mentioned embodiment methods can be implemented by instructing relevant hardware through a computer program. The program can be stored in a computer-readable storage medium. During execution, it may include the procedures of the above-mentioned method embodiments, wherein the storage medium may be a magnetic disk, an optical disc, a read-only memory (ROM), or a random access memory (RAM), etc.

The above embodiments are only used to illustrate the technical solutions of the present disclosure, not to limit them. Other embodiments of the disclosure will be apparent to those skilled in the art from consideration of the specification and practice of the embodiments disclosed herein. It is intended that the specification and examples be considered as examples only and not to limit the scope of the disclosure, with a true scope and spirit of the invention being indicated by the following claims.

What is claimed is:

1. An unmanned aerial vehicle comprising:
a communication controller configured to receive a control instruction from a remote control;
a flight controller electrically connected to the communication interface through a communication interface and a universal serial bus (USB) interface, the communication interface being configured to transmit the control instruction, the USB interface being configured to transmit upgrade data of the flight controller, and the flight controller being configured to control the unmanned aerial vehicle according to the control instruction; and
a center board controller electrically connected to the flight controller through a controller area network (CAN) bus and electrically connected to a load of the unmanned aerial vehicle, the center board controller being configured to receive the control instruction from the communication controller and forward the control instruction to the load.

2. The unmanned aerial vehicle according to claim 1, wherein:
the USB interface is a first USB interface; and
the communication controller is further electrically connected to the center board controller through a second USB interface configured to transmit at least one of upgrade data of the center board controller, log content, or the control instruction.

3. The unmanned aerial vehicle according to claim 2, wherein the communication controller is electrically connected to the load through a third USB interface configured to transmit image data.

4. The unmanned aerial vehicle according to claim 3, wherein the communication controller is electrically connected to an image acquisition device through a fourth USB interface configured to transmit the control instruction.

5. The unmanned aerial vehicle according to claim 4, wherein:
the communication interface is a first communication interface; and
the communication controller is further electrically connected to an ultrasonic sensor through a second communication interface configured to transmit upgrade data of the ultrasonic sensor.

6. The unmanned aerial vehicle according to claim 5, wherein the communication controller is further electrically connected to the flight controller through a third communication interface configured to transmit navigation data.

7. The unmanned aerial vehicle according to claim 6, wherein the communication controller is further electrically connected to the image acquisition device through a fourth communication interface configured to transmit firmware data of the image acquisition device.

8. The unmanned aerial vehicle according to claim 7, wherein at least one of the first communication interface, the second communication interface, the third communication interface, or the fourth communication interface includes a universal asynchronous receiver/transmitter (UART) interface.

9. The unmanned aerial vehicle according to claim 7, wherein the image acquisition device includes a first person view camera.

10. The unmanned aerial vehicle according to claim 7, wherein the fourth communication interface includes a serial peripheral interface (SPI) serial port.

11. The unmanned aerial vehicle according to claim 7, wherein the image acquisition device is electrically connected to the ultrasonic sensor through a serial peripheral interface (SPI) serial port.

12. The unmanned aerial vehicle according to claim 7, wherein the communication controller includes a fifth USB interface electrically connected to the first USB interface, the second USB interface, the third USB interface, and the fourth USB interface through a multi-port repeater.

13. The unmanned aerial vehicle according to claim 12, wherein:
the multi-port repeater is one of a plurality of the multi-port repeaters that are cascaded;
the fifth USB interface is connected with a first-stage multi-port repeater of the plurality of the multi-port repeaters; and
each of the first USB interface, the second USB interface, the third USB interface, and the fourth USB interface includes a port of any one of the plurality of multi-port repeaters.

14. The unmanned aerial vehicle according to claim 12, wherein the multi-port repeater includes a hub.

15. The unmanned aerial vehicle according to claim 3, wherein the load includes at least one of a camera controller, a first camera, or a second camera electrically connected to the communication controller through the third USB interface.

16. The unmanned aerial vehicle according to claim 1, wherein:
the center board controller is a first center board controller configured to implement power supply management of the unmanned aerial vehicle;
a second center board controller is connected between the first center board controller and the load, the second center board controller being configured to:
interact with the load based on a first communication protocol;
interact with the first center board controller based on a second communication protocol; and
implement software adaptation for conversion between the first communication protocol and the second communication protocol.

17. The unmanned aerial vehicle according to claim 16, wherein:
the load includes at least one of a first gimbal, a second gimbal, a first camera, a second camera, or a camera controller;
the first gimbal is electrically connected to the first camera;
the second gimbal is electrically connected to the second camera; and
the camera controller, the first gimbal, and the second gimbal are electrically connected to the second center board controller.

18. The unmanned aerial vehicle according to claim 1, wherein the communication controller includes a Lianxin LC 1860 chip.
